(19) United States
(12) Patent Application Publication
(10) Pub. No.: US 2008/0112195 A1
(43) Pub. Date: May 15, 2008

(54) Transforming circuit for power supplier

(75) Inventors: Shih-An Liang, Taoyuan Hsien (TW); Ching-Wen Huang, Taoyuan Hsien (TW); Mao-Sheng Chaio, Taoyuan Hsien (TW)

Correspondence Address: BIRCH STEWART KOLASCH & BIRCH, PO BOX 747, FALLS CHURCH, VA, 22040-0747, US

(73) Assignee: SPI ELECTRONIC CO., LTD.

(21) Appl. No.: 11/599,462

(22) Filed: Nov. 15, 2006

(51) Int. Cl. H02M 3/337

(52) U.S. Cl. 363/24

(57) ABSTRACT

A transforming circuit for power supplier includes a primary winding coil; a secondary winding coil and a secondary rectifier circuit, an AC power being transformed by the secondary winding coil in accordance with a winding turns ratio relative to the primary winding coil and converted by the secondary rectifier circuit into a first-potential DC power; N+1 sets of potential modifying circuits, connected in parallel with the first-potential DC power, each set of potential modifying circuits being based on the first-potential DC power and transformed thereof into N+1 sets of second-potential DC power at differential potential, N□1. Thereby, DC power at different potentials can be provides so that the power output can be more flexible and effective.

### FIELD OF THE INVENTION

The present invention is related to a transforming circuit, and more particularly to a transforming circuit for power supplier.

### BACKGROUND OF THE INVENTION

In the conventional power supplier, if there is the need to output DC powers at different potentials, +12V, +5V and +3.3V, it has to install three sets of coils at the secondary side of the transforming circuit for the power supplier so that each coil can independently provide DC power at one single potential. However, this kind of design is defective in occupying too much space which might cause inconvenience in use.

Therefore, another kind of design for transforming circuit in power supplier is provided. Please refer to FIGS. 1˜3 which respectively show the conventional forward type, dual-forward type and half-bridge type power suppliers. In this kind of design, there are-two sets of secondary winding coils 5, 6, wherein the secondary winding coil 5 directly supplies the +12V potential output, and the smaller potential outputs, +5V and +3.3V, are concurrently outputted by another secondary winding coil 6. And, the potential output, +3.3V, is achieved by the secondary winding coil 5 utilizing a control circuit 7 with magnetic amplifier feedback controller 71. However, in the circuit design described above, the +12V potential output is limited to the +5V potential output so that the power efficiency thereof is inferior, and if the +12V voltage output terminal has the light and heavy load changing, it will interference the power signals at the +5V and +3.3V voltage output terminals. Besides, if the +3.3V output terminal has a heavy load and the +12V and +5V output terminals have light loads, the duty cycle will become so small that the output power of the +3.3V output terminal may become abnormal owing to the problem of compatibility so as to disable the power supplier.

For avoiding the situation described above, a dummy load is applied at the output terminal, or a level signal is used to correct the output power so as to prevent the interference of light and heavy load changing. However, adding circuits to the output terminal will increase the manufacturing cost and time, so that how to provide a structure which is simple and also can prevent the power output from being influenced by light and heavy load changing at the output terminal is really an issue for the power supplier.

### SUMMARY OF THE INVENTION

The object of the present invention is to provides a transforming circuit used in power supplier which has a flexible power supply and is also power effective, wherein a secondary winding coil for outputting a DC power at a first potential and a secondary rectifier are utilized for maintaining a high power efficiency, and a potential modifying circuit is used to output a DC power sat a second potential so as to achieve the effect of flexible power supply.

For achieving the object described above, the present invention provides a transforming circuit for power supplier includes a primary winding coil; a secondary winding coil and a secondary rectifier circuit, an AC power being transformed by the secondary winding coil in accordance with a winding turns ratio relative to the primary winding coil and converted by the secondary rectifier circuit into a first-potential DC power; N+1 sets of potential modifying circuits, connected in parallel with the first-potential DC power, each set of potential modifying circuits being based on the first-potential DC power and transformed thereof into N+1 sets of second-potential DC power at differential potential, N□1.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing circuits of the conventional forward type power supplier;

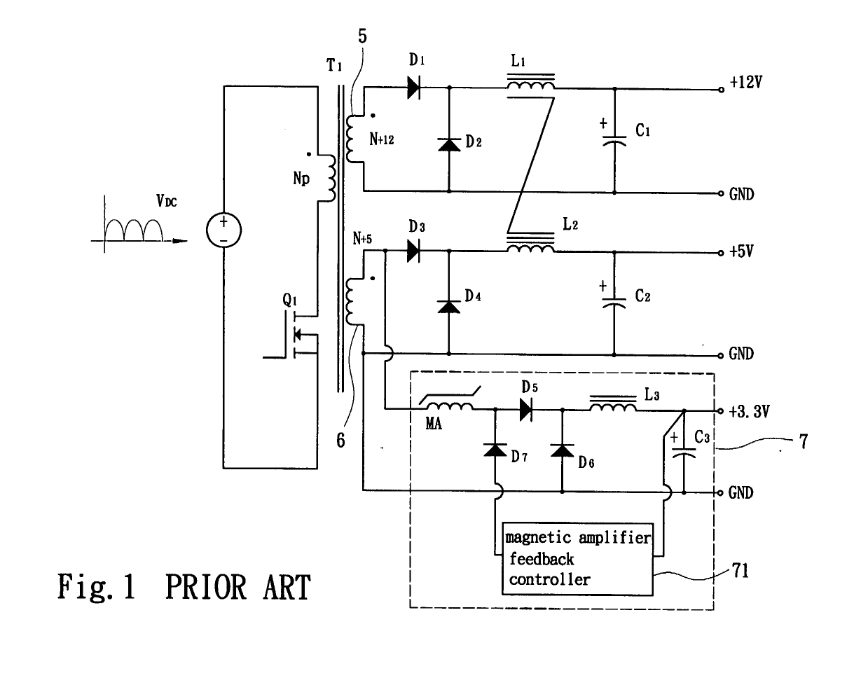

FIG. 2 is a schematic view showing circuits of the conventional dual-forward type power supplier;

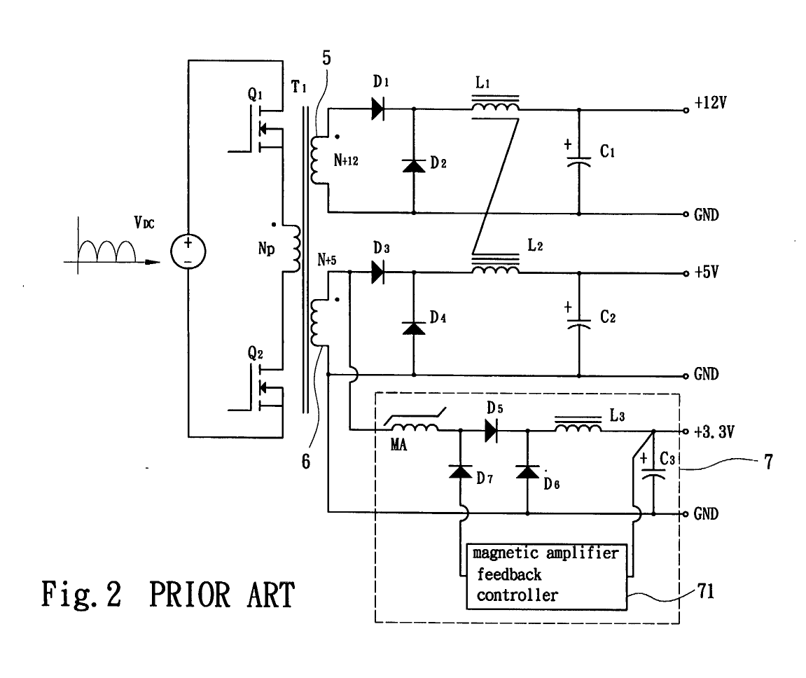

FIG. 3 is a schematic view showing circuits of the conventional half-bridge type power supplier;

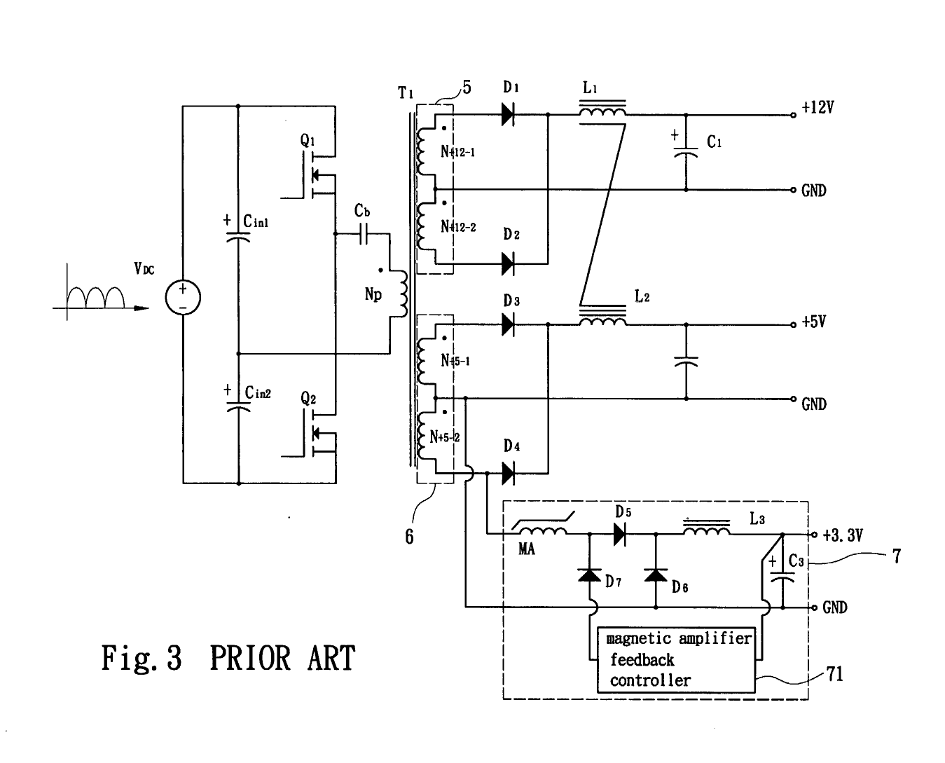

FIG. 4 is a schematic view showing the circuit architecture of a first preferred embodiment according to the present invention;

FIG. 5 is a schematic view showing the circuit architecture of a second preferred embodiment according to the present invention;

FIG. 6 is a schematic view showing the circuit architecture of a third preferred embodiment according to the present invention; and

FIG. 7 is a schematic view showing the circuit architecture of a fourth preferred embodiment according to the present invention.

### DESCRIPTION OF THE PREFERRED EMBODIMENT

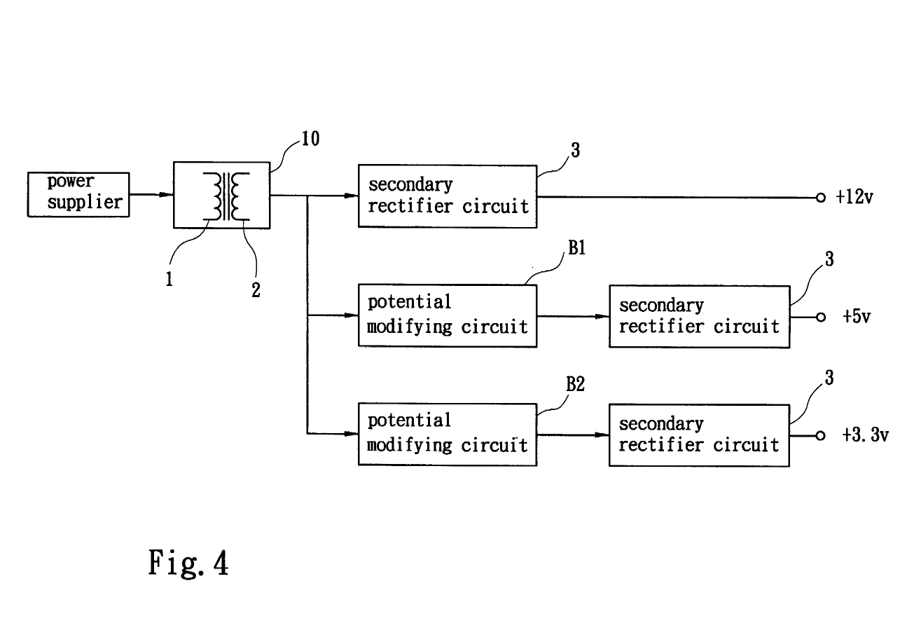

Please refer to FIG. 4, which is a schematic view showing the architecture of a first preferred embodiment according to the present invention.

The present invention is related to a transforming circuit for power supplier, the transforming circuit includes:

a primary winding coil 1, internally installed in a transformer 10 for acquiring AC power from power source;

a single secondary winding coil 2 and a secondary rectifier circuit 3, internally installed in the transformer 10, wherein the AC power is transformed by the secondary winding coil 2 in accordance with a winding turns ratio relative to the primary winding coil 1 and converted by the secondary rectifier circuit 3 into a first-potential DC power, which can be +12V; and

N+1 sets of potential modifying circuits B₁˜B_{N+1}, connected with the first-potential DC power in parallel, each set of potential modifying circuits B₁˜B_{N+1} being based on the first-potential DC power and transformed thereof into N+1 sets of second-potential DC power at differential potential, N□1, wherein the potential modifying circuits B₁˜B_{N+1} can be DC/DC converter, magnetic amplifier feedback control circuit or regulator. In this embodiment, N=2, the output terminal of the single secondary winding coil 2 is connected in parallel with multiple sets of potential modifying circuits B₁, B₂ for respectively outputting DC powers at potentials +5V and +3.3V.

Thereby, the first-potential DC power of the secondary winding coil 2 can output multiple sets of DC powers at differential potentials through the potential modifying circuits B₁, B₂ so as to prevent a defective power efficiency caused from the mutual limitation between different potential output terminals.

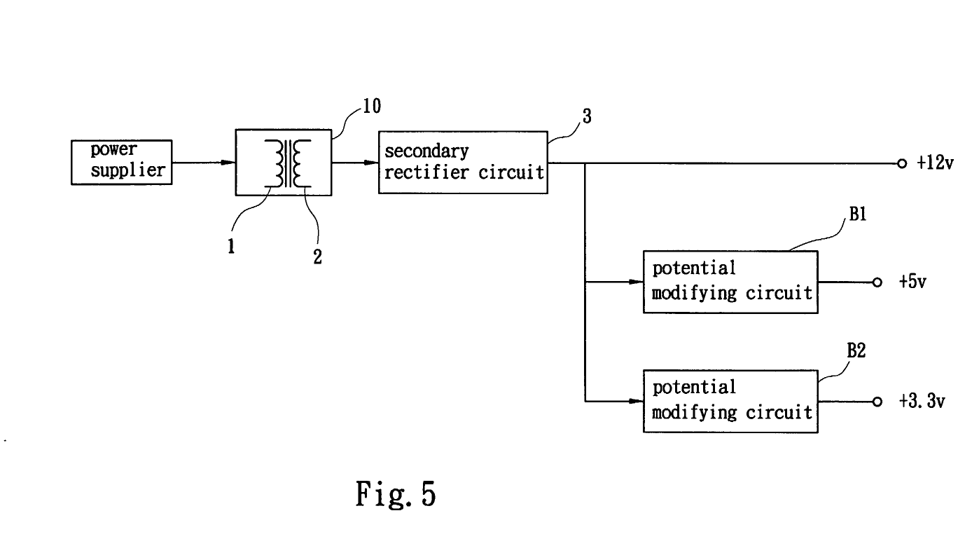

Please refer to FIG. 5, which is a schematic view showing the circuit of a second preferred embodiment according to the present invention.

The difference between this embodiment and the first embodiment is:

The potential modifying circuits B₁, B₂ is connected in parallel with the secondary rectifier circuit 3 for directly transforming the DC power into multiple sets of DC powers at potentials +5V, +3.3V.

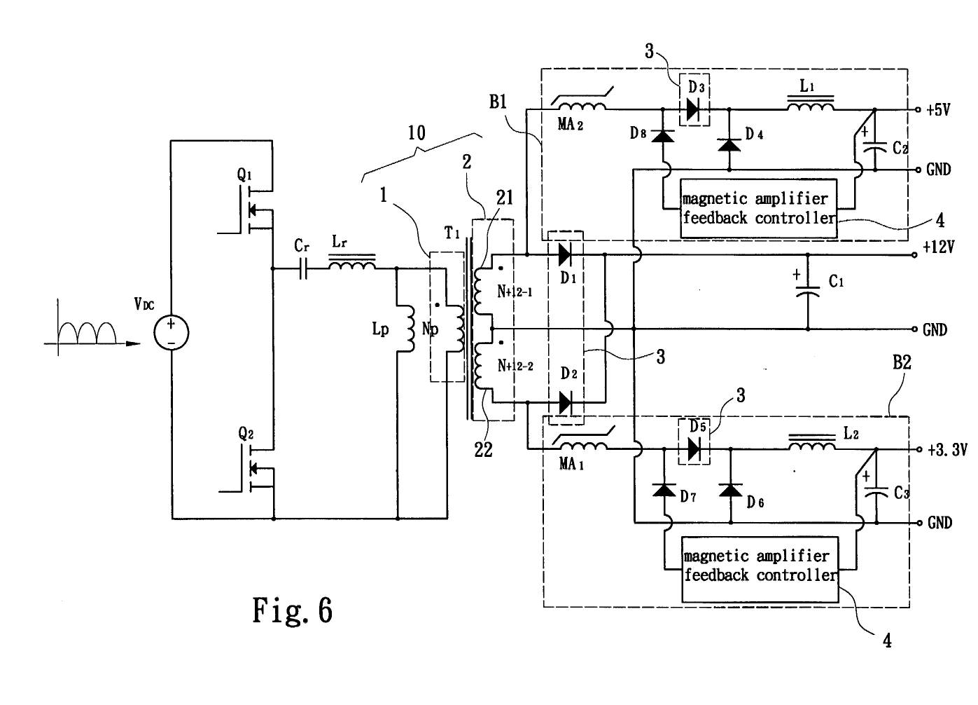

Thereby, there is no need to additionally install the secondary rectifier circuit 3 at the back end of the potential modifying circuits B₁, B₂ so that the circuit complexity can be reduced. Please refer to FIG. 6, which is a schematic view showing the circuit of a third preferred embodiment according to the present invention.

The difference between this embodiment and the first embodiment is:

The secondary winding coil 2 can be constituted by connecting in parallel M+1 winding coil sets, and each winding coil set is connected with one set of potential modifying circuit in parallel, M□1. In this embodiment, M=1, the secondary winding coil 2 is constituted by connecting an upper winding coil set 21 with a lower winding coil set 22 in parallel, wherein the back end of the upper winding coil set 21 is connected in parallel to one single potential modifying circuit B1 for outputting DC power at potential +5V, and the back end of the lower winding coil set 22 is connected in parallel to one single potential modifying circuit B2 for outputting DC power at potential +3.3V, and further, the potential modifying circuits B1; B2 are respectively constituted by control circuits with magnetic amplifier feedback controllers 4.

Thereby, the two independent upper winding coil set 21 and lower winding coil set 22 can output two DC powers at differential potentials +5V and +3.3V.

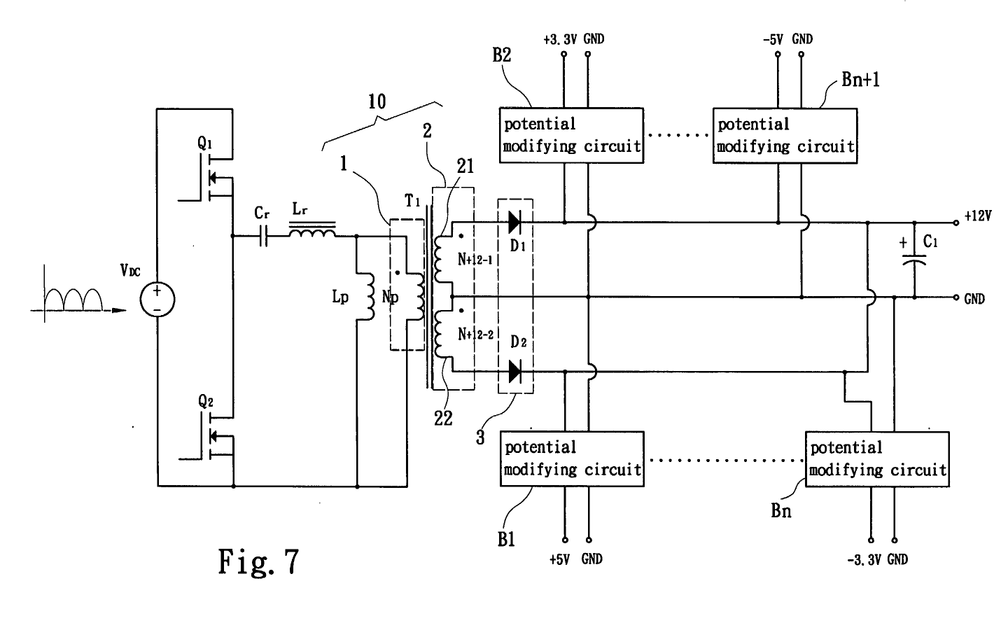

Please refer to FIG. 7, which is a schematic view showing the circuit of a fourth preferred embodiment according to the present invention.

The difference between this embodiment and the third embodiment is:

The single winding coil set is connected in parallel with multiple sets of potential modifying circuits, and the second-potential DC powers outputted by all the potential modifying circuits have different voltage levels, wherein the back ends of the upper winding coil set 21 and the lower winding coil set 22 are connected in parallel with multiple potential modifying circuits B₁˜B_{N+1}, and the potential modifying circuits B₁˜B_{N+1} can output multiple sets of DC powers at identical potential or different potentials.

It should be noted that, in this embodiment, the second-potential DC powers outputted by the potential modifying circuits B₁, B₂, which are connected in parallel with all the single winding coil sets 21, 22, have different voltage levels, but in practice, the potential modifying circuits B₁˜B_{N+1}, which are connected in parallel with part of the single winding coil sets also can output the second-potential DC powers having identical voltage level.

Thereby, the two independent upper winding coil set 21 and lower winding coil set 22 can output multiple sets of identical or different DC powers through multiple sets of potential modifying circuits B₁˜B_{N+1}.

In the aforesaid, the present invention utilizes the secondary winding coil set 2 to output the first-potential DC power for maintaining high power efficiency so that the defective power efficiency caused from mutual limitation between output terminals with different potentials, as described in the prior arts, can be prevented, and the present invention also utilizes the potential modifying circuits B₁˜B_{N+1} to output the second-potential DC power for achieving the effect of flexible power supply so as to prevent the power interference between different potentials.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transforming circuit for power supplier, comprising:
a primary winding coil;
a secondary winding coil and a secondary rectifier circuit, an AC power being transformed by the secondary winding coil in accordance with a winding turns ratio relative to the primary winding coil and converted by the secondary rectifier circuit into a first-potential DC power; and
N+1 sets of potential modifying circuits, connected in parallel with the first-potential DC power, each set of potential modifying circuits being based on the first-potential DC power and transformed thereof into N+1 sets of second-potential DC power at differential potential, N□1.

2. The transforming circuit for power supplier as claimed in claim 1, wherein the potential modifying circuits are DC/DC converters.

3. The transforming circuit for power supplier as claimed in claim 1, wherein the potential modifying circuits are magnetic amplifier feedback control circuits.

4. The transforming circuit for power supplier as claimed in claim 1, wherein the potential modifying circuits are regulators.

5. The transforming circuit for power supplier as claimed in claim 1, wherein the potential modifying circuits are connected in parallel with the output terminal of the secondary winding coil and are independently connected with the secondary rectifier circuit for outputting a second-potential DC power.

6. The transforming circuit for power supplier as claimed in claim 1, wherein the potential modifying circuits are connected in parallel with the secondary rectifier circuit for directly transforming the DC power so as to output a second-potential DC power.

7. The transforming circuit for power supplier as claimed in claim 1, wherein the secondary winding coil is constituted by connecting in parallel M+1 winding coil sets, and each winding coil set is connected with one set of potential modifying circuit in parallel, M□1.

8. The transforming circuit for power supplier as claimed in claim 7, wherein the second-potential DC powers outputted by the potential modifying circuits, which are connected in parallel with part of the single winding coil sets, have an identical voltage level.

9. The transforming circuit for power supplier as claimed in claim 7, wherein the second-potential DC powers outputted by the potential modifying circuits, which are connected in parallel with all the single winding coil sets, have different voltage levels.

10. The transforming circuit for power supplier as claimed in claim 1, wherein the secondary winding coil is constituted by connecting in parallel M+1 winding coil sets, and each winding coil set is connected in parallel with multiple sets of potential modifying circuits, M□1.

11. The transforming circuit for power supplier as claimed in claim 10, wherein the second-potential DC powers outputted by the potential modifying circuits, which are connected in parallel with part of the single winding coil sets, have an identical voltage level.

12. The transforming circuit for power supplier as claimed in claim 10, wherein the second-potential DC powers outputted by the potential modifying circuits, which are connected in parallel with all the single winding coil sets, have different voltage levels.
